(19) United States
(12) Patent Application Publication
(10) Pub. No.: US 2019/0322102 A1
(43) Pub. Date: Oct. 24, 2019

(54) FLUID DISCHARGE HEAD

(71) Applicant: TOSHIBA TEC KABUSHIKI KAISHA, Tokyo (JP)

(72) Inventors: Jun Takamura, Mishima Shizuoka (JP); Takanori Gomi, Numazu Shizuoka (JP)

(21) Appl. No.: 16/372,480

(22) Filed: Apr. 2, 2019

(30) Foreign Application Priority Data
Apr. 18, 2018 (JP) 2018-080043

(51) Int. Cl. B41J 2/045

(52) U.S. Cl. CPC B41J 2/04588; B41J 2/04573; B41J 2/04581

(57) ABSTRACT

According to one embodiment, a fluid discharge head includes a pressure chamber, an actuator, and an application unit. The pressure chamber accommodates a fluid. The application unit applies the driving signal for discharging a fluid from a nozzle communicating with the pressure chamber to the actuator. The driving signal includes a first pulse for driving the actuator to decrease the pressure of the fluid in the pressure chamber and a second pulse for driving the actuator to increase the pressure of the fluid in the pressure chamber. When a half period of a natural oscillation period of the fluid in the pressure chamber is AL, an application time T of the first pulse satisfies a condition of T<AL. A ratio between a voltage of the first pulse and a voltage of the second pulse is −0.95 to −1.05.

### CROSS-REFERENCE TO RELATED APPLICATIONS

This application is based upon and claims the benefit of priority from Japanese Patent Application No. 2018-080043, filed Apr. 18, 2018, the entire contents of which are incorporated herein by reference.

### FIELD

An embodiment described herein relates generally to a fluid discharge head, an inkjet recording apparatus containing the fluid discharge head, and methods related thereto.

### BACKGROUND

An inkjet head (fluid discharge head) that discharges fluid such as ink from nozzles is known. In addition, an inkjet recording apparatus in which such an inkjet head is mounted is known.

An improvement in driving speed (driving frequency) of an inkjet head is desired.

### DESCRIPTION OF THE DRAWINGS

FIG. 1 is a schematic view illustrating an example of a configuration of an inkjet recording apparatus according to an embodiment;

FIG. 2 is a schematic perspective view illustrating an example of a configuration of a fluid discharge head illustrated in FIG. 1;

FIG. 3 is an exploded perspective view illustrating an example of the configuration of the fluid discharge head illustrated in FIG. 1;

FIG. 4 is a schematic cross-sectional view taken along the line F-F of FIG. 2;

FIG. 5 is a view illustrating a state of a pressure chamber;

FIG. 6 is a view illustrating a state of the pressure chamber;

FIG. 7 is a view illustrating a state of the pressure chamber;

FIG. 8 is a block diagram illustrating an example of a main circuit configuration of the inkjet recording apparatus illustrated in FIG. 1;

FIG. 9 is a diagram illustrating an example of a driving waveform according to the embodiment and a pressure waveform of ink when the driving waveform is applied to the actuator;

FIG. 10 is a diagram illustrating an example of a conventional driving waveform and a pressure waveform of ink when the driving waveform is applied to the actuator;

FIG. 11 is a diagram illustrating an example of a conventional driving waveform and a pressure waveform of ink when the driving waveform is applied to the actuator;

FIG. 12 is a graph illustrating variations between nozzle pitches of an example and conventional examples;

FIG. 13 is a graph illustrating landing variation in the relative moving direction of the example and the conventional examples;

FIG. 14 is a schematic diagram illustrating a printing result by an inkjet head of Example 6; and

FIG. 15 is a schematic diagram illustrating a printing result by an inkjet head of Comparative Example.

### DETAILED DESCRIPTION

An exemplary embodiment provides a fluid discharge head capable of being driven at a higher speed than that in the related art.

In general, according to one embodiment, provided is a fluid discharge head including a pressure chamber, an actuator, and an application unit. The pressure chamber accommodates a fluid. The actuator changes the pressure of the fluid in the pressure chamber according to a driving signal to be applied. The application unit applies the driving signal for discharging the fluid from a nozzle communicating with the pressure chamber to the actuator. The driving signal includes a first pulse for driving the actuator to decrease the pressure of the fluid in the pressure chamber and a second pulse for driving the actuator to increase the pressure of the fluid in the pressure chamber. When a half period of a natural oscillation period of the fluid in the pressure chamber is AL, an application time T of the first pulse satisfies a condition of T<AL. A ratio between a voltage of the first pulse and a voltage of the second pulse is −0.95 to −1.05.

Hereinafter, an inkjet recording apparatus according to an embodiment will be described using the drawings. For description, the scales of respective parts may be appropriately changed in each drawing used for the description of the embodiment. In addition, for description, configurations may be omitted in each drawing used for the description of the embodiment.

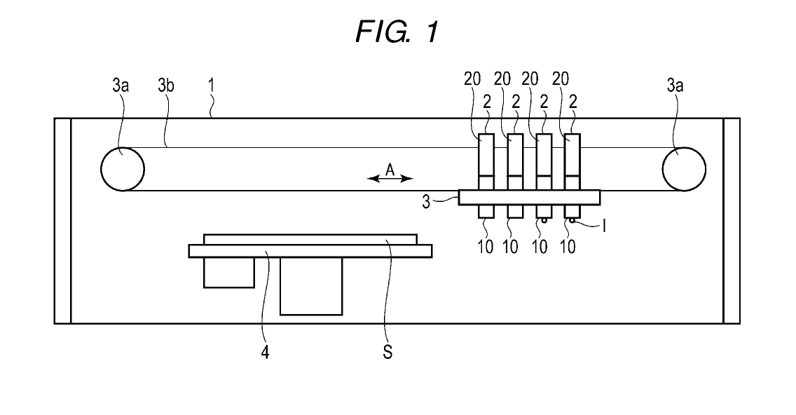

FIG. 1 is a schematic view illustrating an example of a configuration of an inkjet recording apparatus 1 according to an embodiment.

The inkjet recording apparatus 1 forms an image on an image forming medium S or the like by using a fluid recording material such as ink. The inkjet recording apparatus 1 includes, for example, a plurality of fluid discharge portions 2, a head support mechanism 3 that supports the fluid discharge portions 2 to be movable, and a medium support mechanism 4 that supports the image forming medium S to be movable. The image forming medium S is, for example, a sheet-like paper.

As illustrated in FIG. 1, the plurality of fluid discharge portions 2 are supported by the head support mechanism 3 in a state in which the fluid discharge portions are arranged in parallel in a predetermined direction. The head support mechanism 3 is attached to a belt 3b wound around rollers 3a. The inkjet recording apparatus 1 can move the head support mechanism 3 in a main scanning direction A which is orthogonal to a conveying direction of the image forming medium S by rotating the rollers 3a. The fluid discharge portion 2 integrally includes an inkjet head 10 and a circulation device 20. The fluid discharge portion 2 performs a discharge operation of discharging, for example, an ink I as a fluid from the inkjet head 10. As an example, the inkjet recording apparatus 1 is a scanning-type inkjet recording apparatus which performs an ink discharge operation, while reciprocating the head support mechanism 3 in the main scanning direction, to form a desired image on the image forming medium S to be arranged opposite to the head support mechanism. Alternatively, the inkjet recording apparatus 1 may be a single pass type inkjet recording apparatus which performs an ink discharge operation without moving the head support mechanism 3. In this case, the roller 3a and the belt 3b may not be provided. In this case, for example, the head support mechanism 3 is fixed to a housing of the inkjet recording apparatus 1.

Each of the plurality of fluid discharge portions 2 corresponds to any of four color inks, for example, CMYK (cyan, magenta, yellow, and key (black)). That is, each of the plurality of fluid discharge portions 2 corresponds to any of a cyan ink, a magenta ink, a yellow ink and a black ink. Then, each of the plurality of fluid discharge portions 2 discharges the corresponding color ink. Each fluid discharge portion 2 can discharge one or a plurality of fluid droplets of the corresponding color ink continuously for one pixel on the image forming medium S. As the number of continuous discharge for a pixel increases, the amount of fluid droplets landing on one pixel increases. Accordingly, as the number of continuous discharge for a pixel increases, the corresponding color seems darker. Thus, the inkjet recording apparatus 1 can express the gradation of an image to be formed on the image forming medium S.

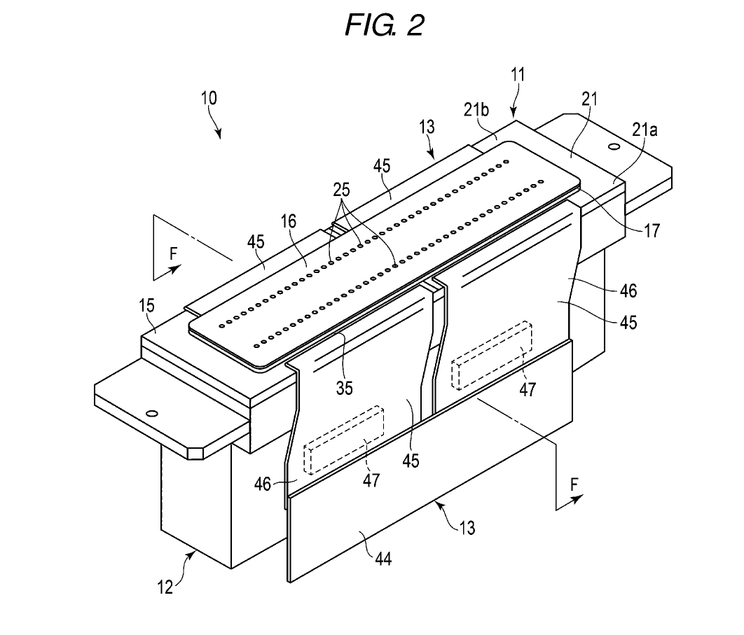

Hereinafter, the inkjet head 10 will be described based on FIGS. 2 to 4. As the inkjet head 10, a circulation type and side-shooter type inkjet head having a shared-wall shear mode type is illustrated in each drawing as an example. However, the inkjet head 10 may be another type of inkjet head. The inkjet head 10 is an example of a fluid discharge head.

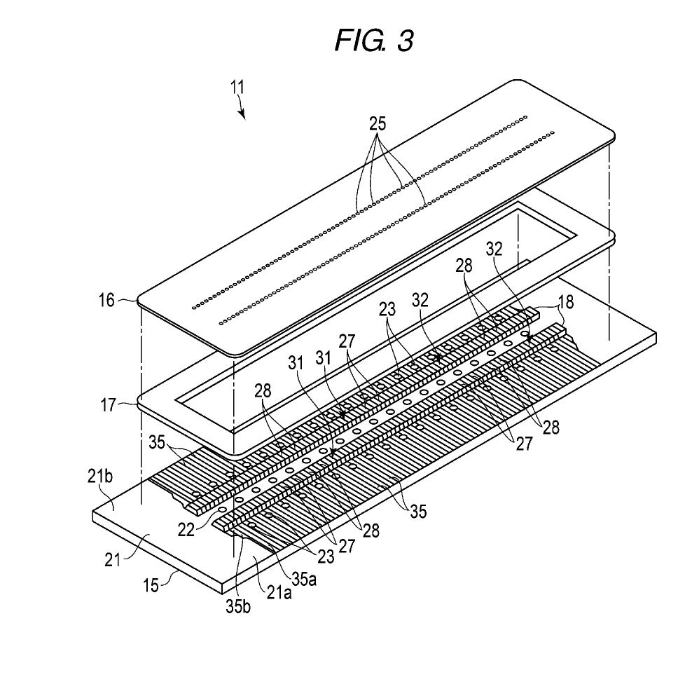

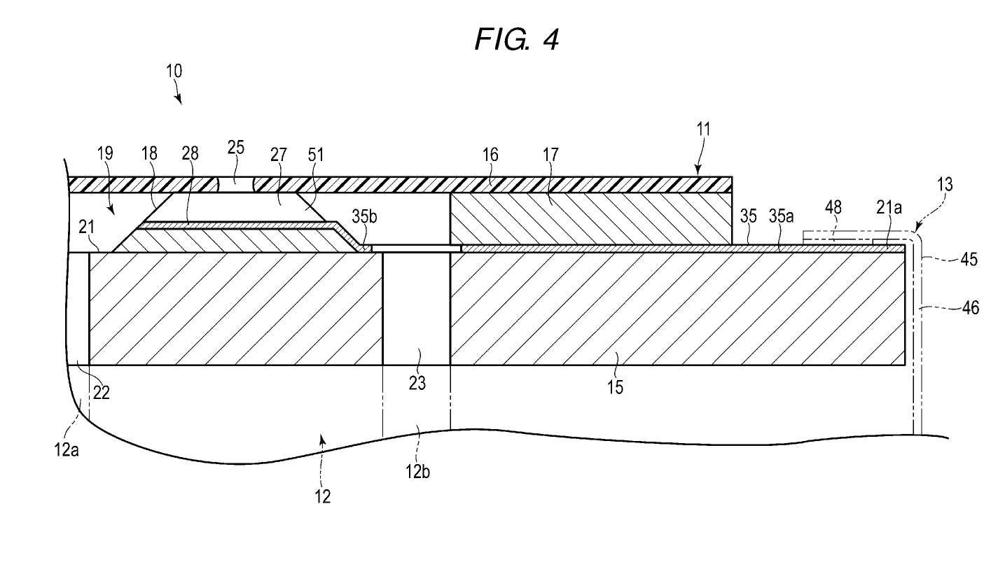

FIG. 2 is a schematic perspective view illustrating an example of a configuration of the inkjet head 10. FIG. 3 is an exploded perspective view illustrating an example of the configuration of the inkjet head 10. FIG. 4 is a schematic cross-sectional view taken along the line F-F of FIG. 2.

The inkjet head 10 is mounted on the inkjet recording apparatus 1 and is connected to an ink tank via a part such as a tube. Such an inkjet head 10 includes a head main body 11, a unit portion 12, and a pair of circuit boards 13. The inkjet head 10 is an example of a waveform generating device.

The head main body 11 is a device for discharging ink. The head main body 11 is attached to the unit portion 12. The unit portion 12 includes a manifold forming a part of a path between the head main body 11 and the ink tank and a member for attaching the unit portion to the inside of the inkjet recording apparatus 1. The pair of circuit boards 13 are respectively attached to the head main body 11.

The head main body 11 includes a base plate 15, a nozzle plate 16, a frame member 17, and a pair of driving elements 18 as illustrated in FIGS. 3 and 4. As illustrated in FIG. 4, an ink chamber 19 to which an ink is supplied is formed inside the head main body 11.

As illustrated in FIG. 3, for example, the base plate 15 is formed in a rectangular plate shape with a ceramic, such as alumina. The base plate 15 has a flat mounting surface 21. In the base plate 15, a plurality of supply holes 22 and a plurality of discharge holes 23 are opened on the mounting surface 21.

The supply holes 22 are provided in parallel in a longitudinal direction of the base plate 15 at the central part of the base plate 15. The supply holes 22 are connected to ink supply portions 12a of the manifold of the unit portion 12. The supply holes 22 are connected to the ink tank in the circulation device 20 via the ink supply portions 12a. The ink in the ink tank is supplied to the ink chamber 19 through the ink supply portions and the supply holes 22.

The discharge holes 23 are arranged in two rows to interpose the supply holes 22 therebetween. The discharge holes 23 are connected with ink discharge portions 12b of the manifold of the unit portion 12. The discharge holes 23 are connected to the ink tank in the circulation device 20 via the ink discharge portions 12b. The ink of the ink chamber 19 is collected to the ink tank through the ink discharge portions 12b and the discharge holes 23. In this manner, the ink is circulated between the ink tank and the ink chamber 19.

The nozzle plate 16 is formed of a rectangular film made of polyimide having, for example, a fluid repelling function on the surface. The nozzle plate 16 faces the mounting surface 21 of the base plate 15. A plurality of nozzles 25 are provided in the nozzle plate 16. The plurality of nozzles 25 are arranged in two rows along the longitudinal direction of the nozzle plate 16.

The frame member 17 is formed in a rectangular frame shape of a nickel alloy, for example. The frame member 17 is interposed between the mounting surface 21 of the base plate 15 and the nozzle plate 16. The frame member 17 is bonded to each of the mounting surface 21 and the nozzle plate 16. That is, the nozzle plate 16 is attached to the base plate 15 via the frame member 17. The ink chamber 19 is surrounded by the base plate 15, the nozzle plate 16 and the frame member 17 as illustrated in FIG. 4.

The driving elements 18 are formed using two plate-shaped piezoelectric bodies formed of lead zirconate titanate (PZT), for example. The two piezoelectric bodies are bonded together so that the directions of polarization thereof are mutually reversed in the thickness direction thereof.

The pair of driving elements 18 are bonded to the mounting surface 21 of the base plate 15 as illustrated in FIG. 3. The pair of driving elements 18 are arranged in parallel within the ink chamber 19 to correspond to the nozzles 25 that are aligned in two rows as illustrated in FIG. 4. The driving elements 18 are formed to have a trapezoidal shape in cross-section. The top portions of the driving elements 18 are bonded to the nozzle plate 16.

A plurality of grooves 27 are provided in the driving elements 18. The grooves 27 respectively extend in a direction that intersects the longitudinal direction of the driving elements 18 and are arranged in the longitudinal direction of the driving elements 18. The plurality of grooves 27 face the plurality of nozzles 25 of the nozzle plate 16. As illustrated in FIG. 4, in the driving elements 18 according to the present embodiment, a plurality of pressure chambers 51, which correspond to driving flow paths for discharging the ink, are arranged in the grooves 27.

An electrode 28 is provided in each of the grooves 27. For example, the electrode 28 is formed by carrying out a photoresist etching process on a nickel thin film. The electrodes 28 cover the inner surfaces of the grooves 27.

As illustrated in FIG. 3, a plurality of wiring patterns 35 are provided from the mounting surface 21 of the base plate 15 to the driving elements 18. For example, these wiring patterns 35 are formed by carrying out a photoresist etching process on a nickel thin film.

The wiring patterns 35 extend from each of one side end portion 21a and the other side end portion 21b of the mounting surface 21. Additionally, in addition to the edges of the mounting surface 21, the side end portions 21a and 21b also include peripheral regions of the edges thereof. Therefore, the wiring patterns 35 may be provided further on the inner side than the edges of the mounting surface 21.

Hereinafter, the wiring pattern 35 that extends from the one side end portion 21a will be described as a representative example. Additionally, the basic configuration of the wiring pattern 35 of the other side end portion 21b is the same as that of the wiring pattern 35 of the one side end portion 21a.

The wiring pattern 35 includes a first section 35a and a second section 35b as illustrated in FIGS. 3 and 4. The first section 35a of the wiring pattern 35 is a portion extending in a linear manner from the side end portion 21a of the mounting surface 21 toward the driving element 18. The first sections 35a extend in parallel to one another. The second section 35b of the wiring pattern 35 is a portion between the end portion of the first section 35a and the electrode 28. The second sections 35b are respectively electrically connected to the electrodes 28.

In a single driving element 18, some electrodes 28 among the plurality of electrodes 28 constitute a first electrode group 31. The other electrodes 28 among the plurality of electrodes 28 constitute a second electrode group 32.

The first electrode group 31 and the second electrode group 32 are divided with the central portion in the longitudinal direction of the driving element 18 as a boundary. The second electrode group 32 is adjacent to the first electrode group 31. For example, the first and second electrode groups 31 and 32 respectively include 159 electrodes 28.

As illustrated in FIG. 2, the pair of circuit boards 13 respectively includes a substrate main body 44, and a pair of film carrier packages (FCPs) 45. The FCPs are also referred to as tape carrier packages (TCPs).

The substrate main body 44 is a rigid printed circuit board that is formed in a rectangular shape. Various electronic components and connectors are mounted on the substrate main body 44. In addition, the pair of FCPs 45 are attached to the substrate main body 44.

The pair of FCPs 45 respectively includes a flexible resin film 46 in which a plurality of pieces of wiring are formed, and a head driving circuit 47 that is connected to the plurality of pieces of wiring. The film 46 is tape-automated bonding (TAB). The head driving circuit 47 is an integrated circuit (IC) for applying a voltage to the electrodes 28. The head driving circuit 47 is fixed to the film 46 with a resin.

The end portion of one FCP 45 is connected to the first section 35a of the wiring pattern 35 by thermo-compression bonding using an anisotropic conductive film (ACF) 48. Therefore, the plurality of pieces of wiring of the FCPs 45 are electrically connected to the wiring pattern 35.

As a result of the FCPs 45 being connected to the wiring pattern 35, the head driving circuits 47 are electrically connected to the electrodes 28 via the wiring of the FCPs 45. The head driving circuits 47 apply a voltage to the electrodes 28 via the wiring of the films 46.

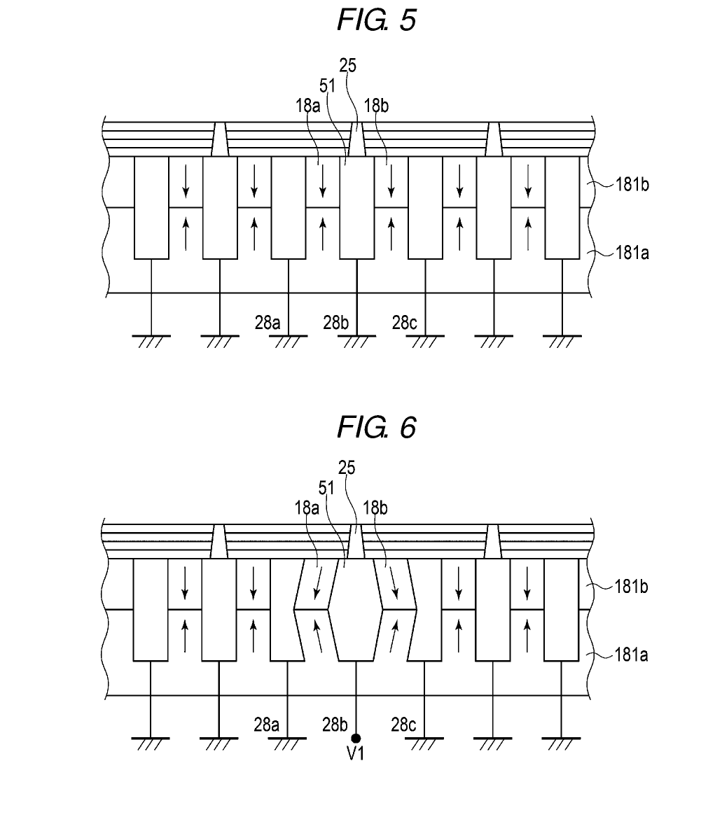

An example of the operation principle of the inkjet head 10 according to the embodiment will be described with reference to FIGS. 5 to 7. Here, the operation principle of the inkjet head 10 will be described focusing on one pressure chamber 51. FIGS. 5 to 7 are views illustrating a state of the pressure chamber 51. As illustrated in FIGS. 5 to 7, the driving element 18 is formed by laminating a piezoelectric member 181a and a piezoelectric member 181b. The polarization directions of the piezoelectric member 181a and the piezoelectric member 181b are opposite to each other along the plate thickness direction. The pressure chamber 51 is interposed between two driving elements 18 (the driving element 18a and the driving element 18b). In addition, the driving element 18a is interposed between two electrodes 28 (the electrode 28a and the electrode 28b). Then, the driving element 18b is interposed between two electrodes 28 (the electrode 28b and the electrode 28c).

FIG. 5 illustrates a state of the pressure chamber 51 in a state in which the electrodes 28a to 28c are set to voltage 0 (ground voltage). In FIG. 5, since the electrodes 28a to 28c have the same potential, no electric field is applied to the driving element 18a and the driving element 18b. Therefore, the driving element 18a and the driving element 18b are not deformed.

FIG. 6 illustrates a state of the pressure chamber 51 in a state in which the electrode 28b is set to voltage V1 and the electrodes 28a and 28c are set to voltage 0 (ground voltage). In the state illustrated in FIG. 6, a negative potential difference is generated between the electrode 28b and both adjacent electrodes 28a and 28c. Due to such a potential difference, the driving element 18a and the driving element 18b undergo shear deformation to expand the volume of the pressure chamber 51.

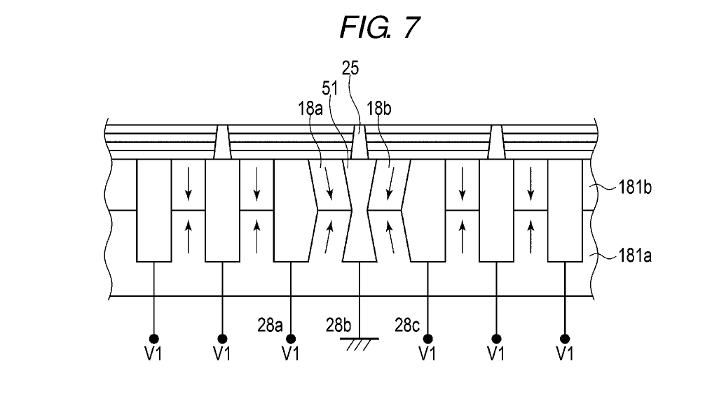

FIG. 7 illustrates a state of the pressure chamber 51 in a state in which the electrode 28a and the electrode 28c are set to the voltage V1 and the electrode 28b is set to the voltage 0 (ground voltage). In the state illustrated in FIG. 7, a positive potential difference, which is opposite to that in FIG. 6, is generated between the electrode 28b and both adjacent electrodes 28a and 28c. Due to such a potential difference, the driving element 18a and the driving element 18b are deformed into a shape opposite to the state illustrated in FIG. 6. That is, the driving element 18a and the driving element 18b undergo shear deformation to contract the volume of the pressure chamber 51.

The inkjet head 10 which operates according to the operation principle as described above can be realized by switching the connection between two kinds of voltage sources such as a voltage source of voltage V1 and a voltage source of voltage 0 (ground voltage) by a switch or the like. In addition, in the above configuration, the voltages of the two kinds of voltage sources may be fixed. Therefore, in the inkjet head 10 operating according to the operation principle as described above, the configuration of the head driving circuit 47 can be made simple.

However, the same operation as described above may be realized by other configurations by changing voltage sources of the inkjet head, changing the voltage supplied from the voltage source, or the like.

When the head driving circuit 47 applies the voltage to the electrode 28, the volume of the pressure chamber 51 provided with the electrodes 28 is increased or decreased by changing the driving element 18 in the shear mode as described above. Thus, the pressure of the ink in the pressure chamber 51 is changed, and the ink is discharged from the nozzle 25. In this manner, the driving element 18 separating the pressure chamber 51 serves as an actuator for applying pressure vibration to the inside of the pressure chamber 51.

The circulation device 20 illustrated in FIG. 1 is integrally connected to the upper portion of the inkjet head 10 by a connecting part made of metal or the like. The circulation device 20 includes a predetermined circulation path configured to allow a fluid to circulate through the ink tank and the inkjet head 10. The circulation device 20 includes a pump for circulating the fluid. The fluid is supplied from the circulation device 20 to the inkjet head 10 through the ink supply portion by the operation of the pump, passes through a predetermined flow path, and then is sent from the inside of the inkjet head 10 to the circulation device 20 through the ink discharge portion.

In addition, the circulation device 20 replenishes the fluid to the circulation path from a cartridge as a replenishing tank, which is provided outside the circulation path.

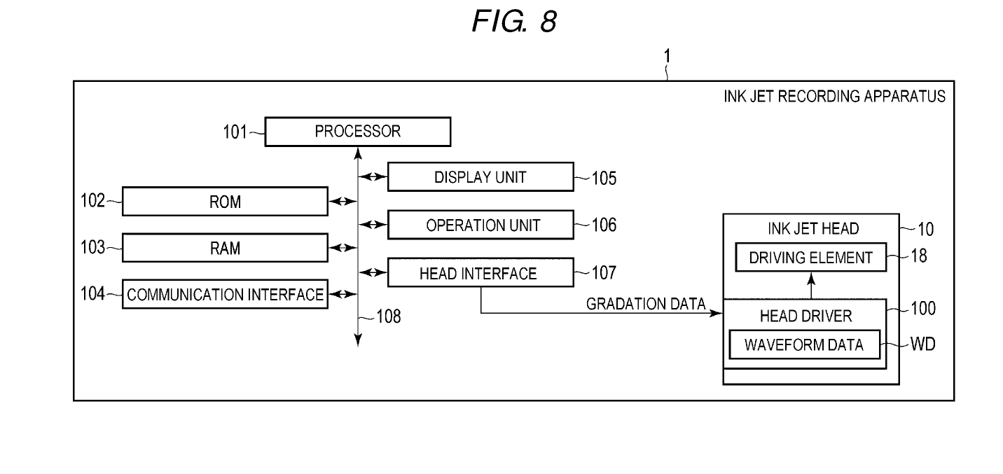

The main circuit configuration of the inkjet recording apparatus 1 will be described. FIG. 8 is a block diagram illustrating an example of the main circuit configuration of the inkjet recording apparatus 1 according to the embodiment.

The inkjet recording apparatus 1 includes a processor 101, a read-only memory (ROM) 102, a random-access memory (RAM) 103, a communication interface 104, a display unit 105, an operation unit 106, a head interface 107, a bus 108, and the inkjet head 10.

The processor 101 corresponds to the central part of a computer that performs a process and control necessary for the operation of the inkjet recording apparatus 1. The processor 101 controls each unit to realize various functions of the inkjet recording apparatus 1 based on a program such as system software, application software or firmware stored in the ROM 102. Examples of the processor 101 include a central processing unit (CPU), a micro processing unit (MPU), a system on a chip (SoC), a digital signal processor (DSP) or a graphics processing unit (GPU). Alternatively, the processor 101 is a combination of these.

The ROM 102 is a nonvolatile memory exclusively used for reading data, which corresponds to the main storage part of a computer having the processor 101 as the center. The ROM 102 stores the above program. In addition, the ROM 102 stores data used for the processor 101 to perform various processes or various setting values and the like.

The RAM 103 is a memory used for reading and writing data, which corresponds to the main storage part of a computer having the processor 101 as the center. The RAM 103 is used as a so-called work area or the like for storing data temporarily used by the processor 101 in performing various processes.

The communication interface 104 is an interface through which the inkjet recording apparatus 1 communicates with a host computer or the like via a network, a communication cable or the like.

The display unit 105 displays a screen for notifying various information to an operator of the inkjet recording apparatus 1. The display unit 105 is, for example, a display such as a liquid crystal display or an organic electro-luminescence (EL) display.

The operation unit 106 receives an operation by an operator of the inkjet recording apparatus 1. For example, the operation unit 106 is a keyboard, a keypad, a touchpad or a mouse. In addition, as the operation unit 106, a touchpad overlaid on the display panel of the display unit 105 can also be used. That is, as the display unit 105 provided with a touch panel, a touch pad provided with a touch panel can be used as the operation unit 106.

The head interface 107 is provided for allowing the processor 101 to communicate with the inkjet head 10. The head interface 107 transmits gradation data and the like to the inkjet head 10 under the control of the processor 101.

The bus 108 includes a control bus, an address bus, a data bus, and the like, and transmits signals sent and received by each unit of the inkjet recording apparatus 1.

The inkjet head 10 includes a head driver 100.

The head driver 100 is a driving circuit for operating the inkjet head 10. The head driver 100 is, for example, a line driver. The head driver 100 stores waveform data WD.

The head driver 100 repetitively generates a single driving signal based on the waveform data WD. Then, the head driver 100 controls the number of times of discharging droplets to each pixel on the image forming medium S based on the gradation data. At every application of the single driving signal, one ink droplet (main fluid droplet) is discharged from the nozzle 25. Accordingly, for example, the inkjet recording apparatus 1 expresses shading by how many ink droplets are discharged to each pixel. That is, as more sets of ink are discharged for one pixel, the density of the corresponding color in the pixel becomes darker.

The head driver 100 is an example of a waveform generating device. In addition, the head driver 100 operates as a generation unit by generating a driving signal.

As an example, the head driver 100 is transferred to an administrator or the like of the head driver 100 in a state in which the waveform data WD is stored. However, the head driver 100 may be transferred to an administrator or the like in a state in which the waveform data WD is not stored in the head driver 100. In addition, the head driver 100 may be transferred to an administrator or the like in a state in which another waveform data is stored. The waveform data WD may be separately transferred to an administrator or the like and written into the head driver 100 under the control of an administrator, a service technician, or the like. At this time, for example, the waveform data WD can be transferred by recording the data on a removable storage medium such as a magnetic disk, a magneto-optical disk, an optical disk, a semiconductor memory or the like, or by downloading the data via a network or the like.

The inkjet head 10 discharges the ink by applying a driving signal having a specific waveform. The waveform of the driving signal is hereinafter referred to as “driving waveform”.

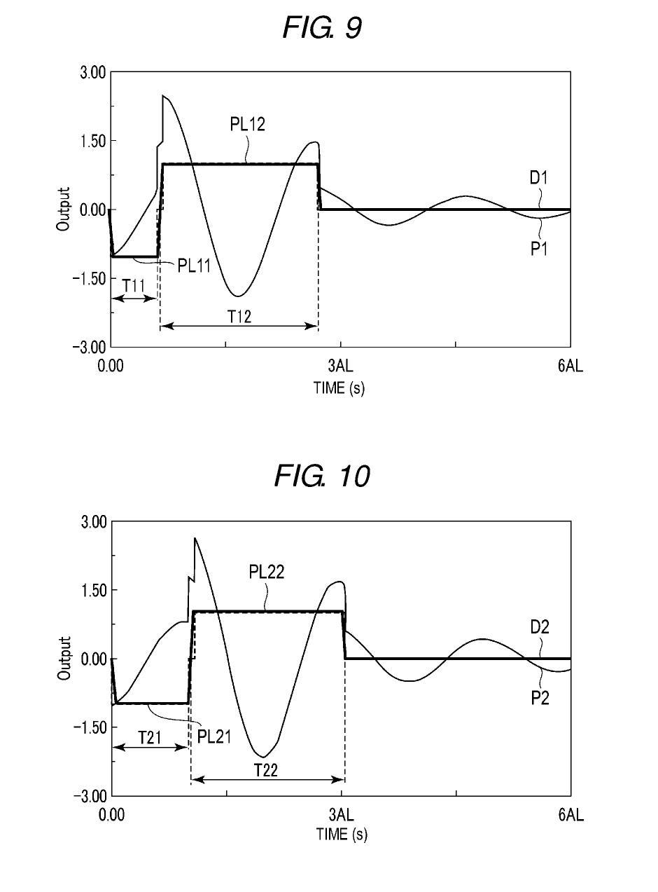

An example of the driving waveform according to the embodiment will be described with reference to FIG. 9. FIG. 9 illustrates an example of the waveform of a driving signal D1 that the head driver 100 applies to the actuator in order to discharge the ink from the nozzle 25. The head driver 100 generates the driving signal D1 based on the waveform data WD and applies the driving signal to the actuator. When the driving signal D1 is applied to the actuator, the ink is discharged from the nozzle 25.

In addition, a pressure waveform P1 of the ink on the meniscus surface at the nozzle 25 when the driving signal D1 is applied to the actuator is also illustrated in FIG. 9.

The driving signal D1 includes an expansion pulse PL11 and a contraction pulse PL12 in this order. The expansion pulse PL11 is a single rectangular wave having a negative potential. The contraction pulse PL12 is a single rectangular wave having a positive potential. The contraction pulse PL12 is applied following the expansion pulse PL11.

The expansion pulse PL11 is an expansion pulse for increasing the volume of the pressure chamber 51. As the volume of the pressure chamber 51 increases, the pressure of the ink in the pressure chamber 51 decreases. Therefore, the expansion pulse PL11 is an example of a first pulse for driving the actuator to decrease the pressure of the fluid in the pressure chamber 51.

Assuming that the half period of the natural oscillation period of the ink in the pressure chamber 51 is 1 AL (acoustic length), an application time T11 of the expansion pulse PL11 is less than 1 AL. By setting the application time T11 of the expansion pulse PL11 to less than 1 AL, the ratio of the residual vibration to the amplitude of the driving waveform becomes small. As a result, it is possible to reduce the residual vibration more efficiently than when the application time T11 of the expansion pulse PL11 is set to 1 AL or more. In addition, the application time T11 of the expansion pulse PL11 is preferably less than 0.7 AL. By shortening the application time T11 of the expansion pulse PL11, the entire length of the driving signal D1 can also be shortened. Therefore, the inkjet head 10 of the embodiment can be driven at a higher speed than the conventional one. Further, with the inkjet head 10 of the embodiment, stable printing can be obtained. When the application of the expansion pulse PL11 is completed, the volume of the pressure chamber 51 returns to the volume before the application of the expansion pulse PL11. Thus, the pressure of the ink in the pressure chamber 51 is increased.

The head driver 100 applies the contraction pulse PL12 following the expansion pulse PL11.

The contraction pulse PL12 is a contraction pulse for decreasing the volume of the pressure chamber 51. As the volume of the pressure chamber 51 decreases, the pressure of the ink in the pressure chamber 51 increases. Accordingly, the contraction pulse PL12 is an example of a second pulse for driving the actuator to increase the pressure of the fluid in the pressure chamber 51.

It is preferable that the application of the contraction pulse PL12 is completed when the pressure of the ink on the meniscus surface of the nozzle 25 indicates a positive peak. That is, an application time T12 of the contraction pulse PL12 is preferably from the start of the application of the contraction pulse PL12 until the pressure of the ink on the meniscus surface at the nozzle 25 indicates a positive peak. By completing the application of the contraction pulse PL12 when the pressure of the ink on the meniscus surface at the nozzle 25 indicates a positive peak, it is possible to reduce the residual vibration. When the application of the contraction pulse PL12 is completed, the volume of the pressure chamber 51 returns to the volume before the application of the contraction pulse PL12. Thus, the pressure of the ink in the pressure chamber 51 is decreased.

When the pressure chamber 51 is contracted and expanded by a configuration in which the connection of two kinds of voltage sources is switched by a switch or the like, the voltage ratio between the expansion pulse PL11 and the contraction pulse PL12 is about −1. The voltage ratio may have an error. For example, an error in a range of about −0.95 to −1.05 may be allowed for the voltage ratio.

### EXAMPLES

The best mode of the inkjet head of the embodiment will be described with reference to Examples and Comparative Example. The Examples and Comparative Example do not limit the scope of the embodiments. Unless otherwise indicated in the following examples and elsewhere in the specification and claims, all parts and percentages are by weight, all temperatures are in degrees Centigrade, and pressure is at or near atmospheric pressure.

### Experiment 1

Experiment 1 is performed using three kinds of inkjet heads of Example 1 and Conventional Examples 1 and 2.

### Example 1

An inkjet head of Example 1 discharges ink by the driving signal D1 with an application time of the expansion pulse PL11 set to 1.75 μsec. The AL of Example 1 is 2.85 μsec. In addition, in the following Conventional Example 1, Conventional Example 2, Examples 2 to 6, and Comparative Example 1, AL is likewise 2.85 μsec.

### Conventional Example 1

An inkjet head of Conventional Example 1 discharges ink by a driving signal D2 as illustrated in FIG. 10. FIG. 10 illustrates an example of a conventional driving signal D2. In addition, FIG. 10 also illustrates a pressure waveform P2 of the ink when the driving signal D2 is applied to the actuator. Similar to the driving signal D1, the driving signal D2 includes an expansion pulse PL21 and a contraction pulse PL22 in this order. However, an application time T21 of the expansion pulse PL21 is 1 AL. In addition, an application time T22 of the contraction pulse PL22 is 2 AL.

### Conventional Example 2

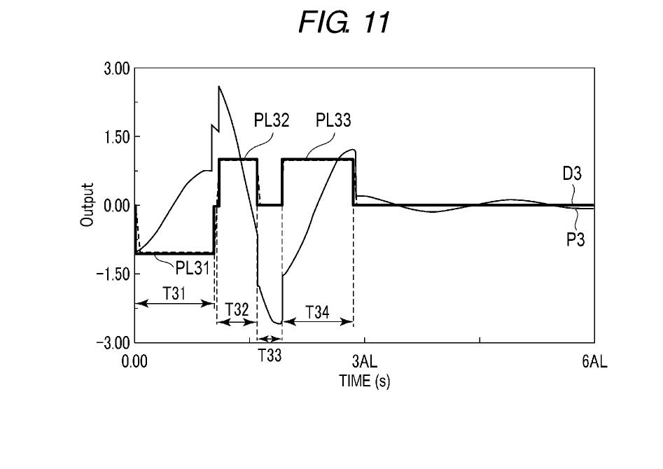

An inkjet head of Conventional Example 2 discharges ink by a driving signal D3 as illustrated in FIG. 11. FIG. 11 illustrates an example of a conventional driving signal D3. In addition, FIG. 11 also illustrates a pressure waveform P3 of the ink when the driving signal D3 is applied to the actuator. The driving signal D3 includes an expansion pulse PL31, a first contraction pulse PL32, and a second contraction pulse PL33 in this order. That is, the driving signal D3 includes two contraction pulses unlike the driving signal D1 and the driving signal D2. An application time T31 of the expansion pulse PL31 is 1 AL. An application time T32 of the first contraction pulse PL32 is 0.5 AL. A time T33 from the completion of the application of the first contraction pulse PL32 to the start of the application of the second contraction pulse PL33 is 0.33 AL. An application time T34 of the second contraction pulse PL33 is 0.96 AL.

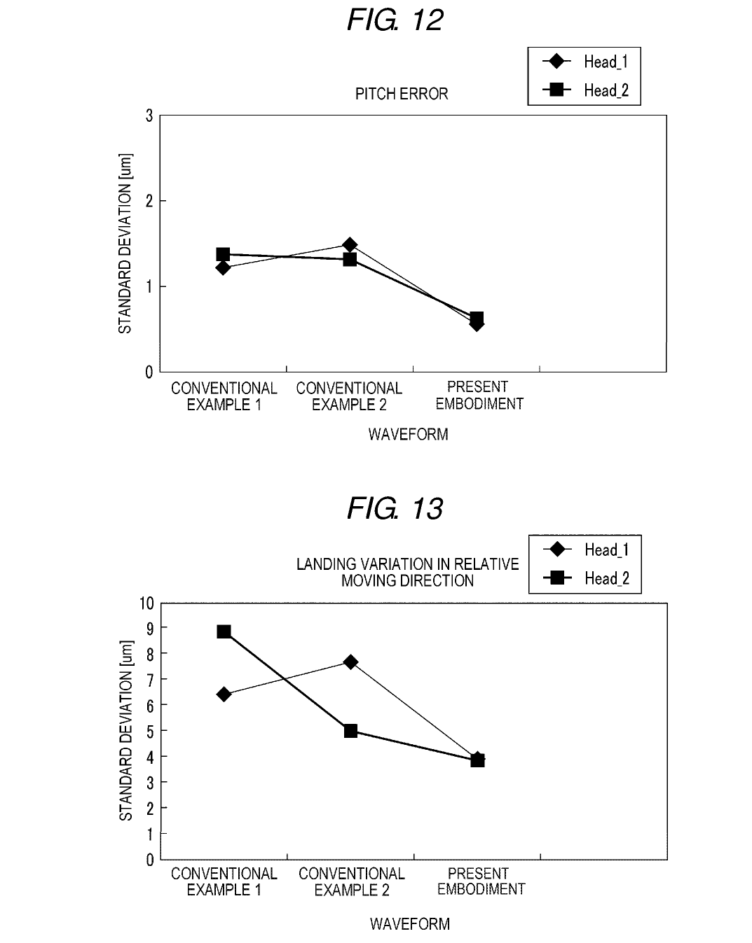

The inkjet heads of Example 1 and Conventional Examples 1 and 2 are used to discharge the ink respectively. FIG. 12 illustrates the measurement results of the landing variation between the nozzle pitches (landing variation in the pitch direction) at this time. In addition, FIG. 13 illustrates the measurement results of the landing variation in the relative moving direction at this time.

The pitch direction is a direction in which the nozzles are arranged. The nozzles are arranged in a direction perpendicular to a direction in which the image forming medium S is conveyed, and the arranged direction is the pitch direction. Then, the relative moving direction is the same direction as the direction in which the image forming medium S is conveyed and is a direction orthogonal to the pitch direction.

From FIG. 12, it is found that Example 1 has a smaller pitch error than Conventional Examples 1 and 2. In addition, from FIG. 13, it is found that the landing variation in the relative moving direction is smaller in Example 1 than in Conventional Examples 1 and 2. That is, it is found that the variation is small in either the pitch direction or the relative moving direction in Example 1.

Further, it is found that the pressure waveform P1 of the embodiment illustrated in FIG. 9 has a smaller amplitude after the completion of the application of the contraction pulse than the pressure waveform P2 illustrated in FIG. 10. That is, the driving signal D1 has smaller residual vibration than the driving signal D2.

The driving signal D3 illustrated in FIG. 11 includes two contraction pulses. In contrast, the driving signal D1 of the embodiment illustrated in FIG. 9 includes one contraction pulse. Accordingly, the inkjet head of the embodiment requires fewer switching times as compared with the inkjet head of Conventional Example 2 to which the driving signal D3 is applied. As a result, the inkjet head of the embodiment can reduce the heat generation as compared with the inkjet head of Conventional Example 2 to which the driving signal D3 is applied.

### Experiment 2

### Example 2

An inkjet head of Example 2 discharges ink by the driving signal D1 with an application time of the expansion pulse PL11 set to 0.63.

### Example 3

An inkjet head of Example 3 discharges ink by the driving signal D1 with an application time of the expansion pulse PL11 set to 0.67.

### Example 4

An inkjet head of Example 4 discharges ink by the driving signal D1 with an application time of the expansion pulse PL11 set to 0.70.

### Example 5

An inkjet head of Example 5 discharges ink by the driving signal D1 with an application time of the expansion pulse PL11 set to 0.74.

Regarding the inkjet heads of Examples 2 to 5 and Conventional Example 1, printing is performed to check whether or not printing omission occurs. The results are illustrated in Table 1.

TABLE 1
Printing Quality (Printing Omission)

| | | | | | Con- |
|---|---|---|---|---|---|
| | | | | | ventional |
| | Example 2 | Example 3 | Example 4 | Example 5 | Example 1 |
| Application | 0.63 AL | 0.67 AL | 0.70 AL | 0.74 AL | — |
| time of | | | | | |
| expansion | | | | | |
| pulse PL11 | | | | | |
| Printing | Not | Not | Not | Not | Occurred |
| omission | occurred | occurred | occurred | occurred | |

From Table 1, it is found that printing omission occurs in Conventional Example 1. In contrast, it is found that printing omission does not occur in any Examples 2 to 5. Accordingly, the inkjet heads of Examples 2 to 5 exhibit better printing quality than the inkjet head of Conventional Example.

Also, from Table 1, it is found that when the application time of the expansion pulse PL11 is 0.63 AL or more and 0.74 AL or less, printing omission does not occur. Therefore, in view of print quality, the application time of the expansion pulse PL11 is preferably 0.614 AL or more and 0.74 AL or less.

### Experiment 3

### Example 6

An inkjet head of Example 6 discharges ink by the driving signal D1 with an application time of the expansion pulse PL11 set to (0.5 AL+0.2 μsec).

### Comparative Example 1

An inkjet head of Comparative Example 1 discharges ink by the driving signal D1 with an application time of the extension pulse PL11 set to 0.5 AL.

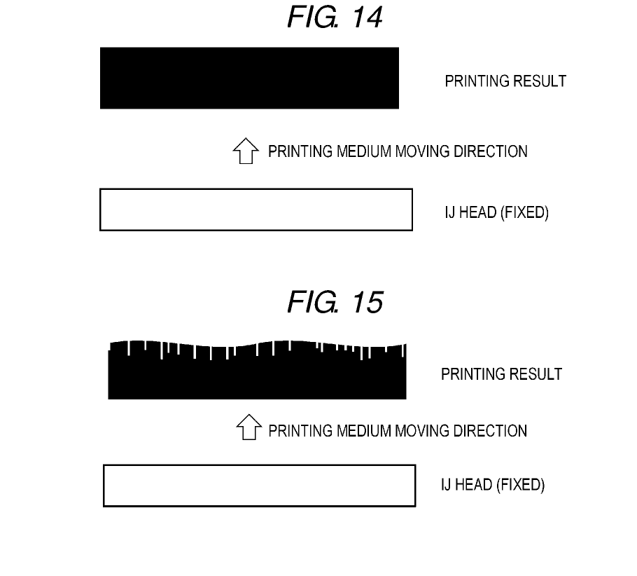

For each of the inkjet heads of Example 6 and Comparative Example 1, printing is performed to compare the printing quality. The results are illustrated in FIGS. 14 and 15. FIG. 14 is a schematic diagram illustrating a printing result by the inkjet head of Example 6. FIG. 15 is a schematic diagram illustrating a printing result by an inkjet head of Comparative Example 1. The IJ head in FIGS. 14 and 15 is an abbreviation for the inkjet head.

As illustrated in FIG. 15, in the printing result of Comparative Example 1, the start of printing is distorted or printing omission occurs intermittently. On the other hand, as illustrated in FIG. 14, in the printing result of Example 6, stable discharge is possible from the start of printing, and sharp printing is obtained compared to FIG. 15. Therefore, it is found that the printing result of Example 6 illustrated in FIG. 14 is better than the printing result of Comparative Example 1 illustrated in FIG. 15 in terms of printing quality. From the above, the application time of the expansion pulse PL11 is preferably 0.5 AL+0.2 μsec or more in view of printing quality.

### Experiment 4

The ink is discharged by the inkjet head by the driving signal D1 in which the application time and the driving voltage of the expansion pulse PL11 are variously changed. Table 2 illustrates the evaluation results of the respective print qualities based on the number of random omissions. The application time of the expansion pulse PL11 is set in a range from 1.6 μsec (D160) to 2.4 μsec (D240). In addition, the driving voltage is set in a range from (reference voltage −3 V) to (reference voltage +4 V). The reference voltage in Experiment 4 is a voltage at which the inkjet head discharges 90 picoliters with 7 ink droplets. In addition, the length of AL in Experiment 4 is about 2.95 μsec due to the combination of the inkjet head and the ink.

TABLE 2
Printing Quality

| | Application time | | | | | |
|---|---|---|---|---|---|---|
| | D | D | D | D | D | D |
| Driving voltage | 160 | 180 | 200 | 220 | 230 | 240 |
| Reference voltage −3 V | D | D | D | D | D | D |
| Reference voltage −2 V | D | B2 | B2 | B2 | D | D |
| Reference voltage −1 V | B2 | A | A | A | A | B1 |
| Reference voltage | A | A | A | A | A | B2 |
| Reference voltage +1 V | A | A | A | A | A | A |
| Reference voltage +2 V | C | C | C | A | A | B2 |
| Reference voltage +3 V | — | D | D | B4 | A | A |
| Reference voltage +4 V | — | — | — | D | B1 | D |

A: No random omission occurs and the printing quality is good.
B1 to B4: A few random omissions occur (the number is the number of occurrences of random omissions).
C: Many random omissions occur.
D: Out of the good printing range

When A to D illustrated in Table 2 are arranged in order of good evaluation results of the printing quality, the order is A, B, C and D. That is, A indicates the best result. B illustrated in Table 2 is shown with numbers after B like B1 to B4. The number indicates the number of occurrences of random omissions. As the number of occurrences of random omissions becomes smaller, the result becomes better. Accordingly, from Table 2, it is found that there is a driving voltage at which a good printing result of A or B can be obtained at the application time of the expansion pulse PL11 within a range of 0.54 AL (D160) to 0.81 AL (D240). Particularly, it is found that a good printing result of A or B can be obtained at the driving voltage in a range of reference voltage −1 V to reference voltage +1 V over the entire range of D160 to D240. In addition, it is found that in a range of 0.61 AL (D180) to 0.78 AL (D230), the range of the driving voltage at which the best printing result of A can be obtained is wider than the ranges of D160 and the D240.

The above embodiment can also be modified as follows.

In addition to the above embodiment, for example, the inkjet head 10 may adopt a structure for discharging the ink by deforming a vibrating plate with static electricity, a structure for discharging the ink from the nozzle by using thermal energy with a heater, or the like. In these cases, the vibrating plate, the heater, and the like are actuators for applying pressure vibration to the inside of the pressure chamber 51.

In the above embodiment, the driving element 18 undergoes shear mode deformation. However, the driving element 18 may undergo deformations other than the shear mode.

The inkjet recording apparatus 1 of the embodiment is an inkjet printer that forms a two-dimensional image on the image forming medium S with ink. However, the inkjet recording apparatus of the embodiment is not limited thereto. For example, the inkjet recording apparatus of the embodiment may be a 3D printer, an industrial manufacturing machine, a medical machine, or the like. When the inkjet recording apparatus of the embodiment is a 3D printer, an industrial manufacturing machine, a medical machine, or the like, for example, in the inkjet recording apparatus of the embodiment, a substance to be a material, a binder for hardening the material, or the like is discharged from the inkjet head to form a three-dimensional object.

The inkjet recording apparatus 1 of the embodiment includes four fluid discharge portions 2, and the color of the ink I used by each of the fluid discharge portions 2 is cyan, magenta, yellow or black. However, the number of fluid discharge portions 2 included in the inkjet recording apparatus is not limited to 4, and may not be plural. In addition, the color and the characteristics of the ink I used by each of the fluid discharge portions 2 are not limited thereto.

In addition, the fluid discharge portion 2 is capable of discharging a transparent glossy ink, an ink which develops color when irradiated with infrared rays or ultraviolet rays, or other special inks. Further, the fluid discharge portion 2 may be one capable of discharging a fluid other than ink. The fluid discharged by the fluid discharge portion 2 may be a dispersion liquid such as a suspension liquid. Examples of the fluid discharged by the fluid discharge portion 2 other than ink include a fluid including conductive particles for forming a wiring pattern of a printed wiring board, a fluid containing cells for artificially forming a tissue, an organ or the like, a binder such as an adhesive, a wax, a liquid resin, and the like.

Other than in the operating examples, or where otherwise indicated, all numbers, values and/or expressions referring to quantities of ingredients, reaction conditions, etc., used in the specification and claims are to be understood as modified in all instances by the term “about.”

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A fluid discharge head, comprising:
a pressure chamber that accommodates a fluid;
an actuator that changes the pressure of the fluid in the pressure chamber according to a driving signal to be applied; and
an application unit that applies the driving signal to the actuator for discharging the fluid from a nozzle communicating with the pressure chamber, wherein
the driving signal comprises a first pulse to decrease the pressure of the fluid in the pressure chamber and a second pulse to increase the pressure of the fluid in the pressure chamber,
an application time T of the first pulse satisfies a condition of T<AL where AL is a half period of a natural oscillation period of the fluid in the pressure chamber, and
a ratio between a voltage of the first pulse and a voltage of the second pulse is from about −0.95 to about −1.05.

2. The head according to claim 1, wherein
the application time T of the first pulse satisfies another condition of T≥(0.5 AL+0.2 (μsec)).

3. The head according to claim 1, wherein
the application time T of the first pulse satisfies another condition of 0.54 AL≤T≤0.81 AL.

4. The head according to claim 1, wherein
the application of the second pulse is completed when the pressure of the fluid at a meniscus surface of the nozzle is at a peak.

5. The head according to claim 1, wherein
the actuator comprises two piezoelectric members.

6. The head according to claim 1, further comprising
a plurality of pressure chambers and a corresponding plurality of actuators.

7. The head according to claim 1, wherein
the fluid discharge head is an inkjet head.

8. An inkjet recording apparatus comprising the fluid discharge head according to claim 1.

9. A fluid discharge head, comprising:
a pressure chamber that accommodates a fluid;
an actuator that changes the pressure of the fluid in the pressure chamber according to a driving signal to be applied; and
an application unit that applies the driving signal to the actuator, wherein
the driving signal comprises a first pulse to decrease the pressure of the fluid in the pressure chamber and a second pulse to increase the pressure of the fluid in the pressure chamber, and
an application time T of the first pulse satisfies a condition of T<0.7 AL where AL is a half period of a natural oscillation period of the fluid in the pressure chamber.

10. The head according to claim 9, wherein
the application time T of the first pulse satisfies another condition of T≥(0.5 AL+0.2 (μsec)).

11. The head according to claim 9, wherein
the application time T of the first pulse satisfies another condition of 0.54 AL≤T≤0.81 AL.

12. The head according to claim 9, wherein
the application of the second pulse is completed when the pressure of the fluid at a meniscus surface of the nozzle is at a peak.

13. The head according to claim 9, wherein
the actuator comprises two piezoelectric members.

14. The head according to claim 9, further comprising
a plurality of pressure chambers and a corresponding plurality of actuators.

15. The head according to claim 9, wherein
the fluid discharge head is an inkjet head.

16. An inkjet recording apparatus comprising the fluid discharge head according to claim 9.

17. A fluid discharge method, comprising:
applying a driving signal to an actuator that changes a pressure of fluid in a pressure chamber thereby discharging the fluid from a nozzle communicating with the pressure chamber, wherein
the driving signal comprises a first pulse to decrease the pressure of the fluid in the pressure chamber and a second pulse to increase the pressure of the fluid in the pressure chamber, and at least one of:
an application time T of the first pulse satisfies a condition of T<AL where AL is a half period of a natural oscillation period of the fluid in the pressure chamber, and a ratio between a voltage of the first pulse and a voltage of the second pulse is from about −0.95 to about −1.05, and
an application time T of the first pulse satisfies a condition of T<0.7 AL where AL is a half period of a natural oscillation period of the fluid in the pressure chamber.

18. The method according to claim 17, wherein
the application time T of the first pulse satisfies another condition of T≥(0.5 AL+0.2 (μsec)).

19. The method according to claim 17, wherein
the application time T of the first pulse satisfies another condition of 0.54 AL≤T≤0.81 AL.

20. The method according to claim 17, wherein
the application of the second pulse is completed when the pressure of the fluid at a meniscus surface of the nozzle is at a peak.
